(19) United States
(12) Patent Application Publication
(10) Pub. No.: US 2009/0047535 A1
(43) Pub. Date: Feb. 19, 2009

(54) Flexible, Conformal, and Self-Securing Door Cover

(76) Inventor: Michael G. Crilly, Hatboro, PA (US)

Correspondence Address: Michael G. Crilly, Esquire;Law Offices of Michael Crilly, 104 South York Road, Hatboro, PA, 19040, US

(21) Appl. No.: 12/162,416

(22) PCT Filed: Feb. 8, 2007
(86) PCT No.: PCT/US2007/003494

§ 371 Date: Jul. 28, 2008

Related U.S. Application Data
(60) Provisional application No. 60/772,506, filed on Feb. 10, 2006.

(51) Int. Cl. B32B 9/00

(52) U.S. Cl. 428/542.6

(57) ABSTRACT

A rectangular-shaped door cover (1) capable of covering a door (10) in a decorative fashion is presented. The invention includes a sleeve-shaped element having two open and two closed sides. The door cover (1) includes one or more stretchable fabric sheets which conform to a door (10) so as to cover the front surface (11), back surface (12), top side edge (15), and bottom side edge (16) along a door (10) without obstructing locks and hinges thereon. The fabric material is stretchable so as to fit over and cover a door (10) and is sufficiently resilient so as to contract along its length after placement onto a door (10), thereby securing the door cover (1) thereto in a fixed yet removable fashion. The invention has immediate applicability to the decoration of doors during holidays, celebrations, and other events, as well as for advertising, promotion, and identification purposes.

### CROSS REFERENCE TO RELATED APPLICATIONS

This application is based upon and claims priority from U.S. Provisional Application No. 60/772,506 filed Feb. 10, 2006 and PCT Application No. PCT/US2007/003494 filed on Feb. 8, 2007, the contents of which are hereby incorporated in their entirety by reference thereto.

### FEDERALLY SPONSORED RESEARCH AND DEVELOPMENT

None.

### BACKGROUND OF THE INVENTION

1. Field of the Invention

The present invention generally relates to a decorative cover for doors. Specifically, the invention is a four-sided covering having two closed and two open sides. The invention is composed of a fabric material which is stretched to fit over and contact the horizontal edges of a door, so as to cover the door in a self-securing, conformal, and removable fashion. The open sides of the cover ensure that the vertical edges of the door with locking hardware and hinges are unobstructed.

2. Background

A variety of coverings for doors are provided in the related arts. Examples are discussed below to clarify the related arts and distinguish each from the present invention.

Wade et al., U.S. Pat. No. 6,672,366, discloses a covering for use with French doors. The covering includes a pair of fabric sheets forming a sleeve closed on three-sides which are stretched across a frame composed of tube-shaped members. In another embodiment, a fabric sheet is stretched about a frame in a canvas-like fashion, thus providing a decorative surface along one surface. The door covering is thereafter hung separate and apart from a door via hooks or posts which project out from a door frame. As such, Wade et al. does not provide a covering which surrounds and covers a door.

Wilson, U.S. Pat. No. 6,308,474, discloses a doorway shield including a planar sheet having J-shaped hooks disposed about the perimeter thereof. Wilson does not allow for the decoration of the exterior and interior surfaces along a door. The application of Wilson to cover both surfaces along a door requires an overlapping of J-shaped hooks, thus interfering with the closing and opening of the door and with the decorative features along one or both sheets.

Plager, U.S. Pat. No. 6,279,280, discloses an aesthetic security doorway including a support structure and a number of cross bars which are shaped and arranged to provide a decorative design. As such, Plager does not surround and cover a door in a flexible and conformal fashion.

Zinbarg, U.S. Pat. No. 6,035,919, discloses a decorative cover for garage doors. The cover includes at least one flexible panel which is fixed at one end to a garage door and attached at the other end via a resilient member or rubber band. The resilient member keeps the flexible panel taut as the garage door is opened and closed. As such, Zinbarg does not describe a covering which surrounds and covers both interior and exterior surfaces of a door.

Bryant, U.S. Pat. No. 5,922,437, discloses a fitted cover to decorate one surface along a door. The cover includes a pliable, fabric material which is folded about its perimeter and stitched to form a channel. A drawstring or elastic ribbon within the channel secures the cover to a door. As such, Bryant does not describe a covering which is capable of surrounding and covering both interior and exterior surfaces of a door.

Davidson, U.S. Pat. No. 5,649,390, discloses a decorative cover for garage doors composed of a weather resistant material. The cover wraps around the top and bottom ends of the garage door and is thereafter joined together via bung ee-type cords. As such, Davidson does not describe a covering which surrounds and covers both interior and exterior surfaces of a door.

Ullman, U.S. Pat. No. 5,351,733, discloses a reversible protective device for doors intended to prevent damage to a door caused when moving articles through a doorway. The protective device is in the form of a padded panel which is slightly wider than the width of a door and having bands and straps for attachment purposes. The padded panel extends to cover the edges of the door, thereby interfering with the opening, closing, and locking thereof.

Saruwatari et al., U.S. Pat. No. 5,255,727, discloses a two-piece protective door cover comprised of a non-stretchable canvas or duck attached to the vertical edges of the door along its left and right sides. The cover includes exterior and interior panels and a pair of side panels with cutouts for locking hardware and hinges. Straps are provided at the top and bottom to further secure the cover to the upper and lower horizontal edges of a door. The cover requires hook-and-loop fasteners to properly secure the cover about a door.

Makarevich et al., U.S. Pat. No. 5,123,223, discloses a decorative attachment for a door. The device includes a sheet covering all or a portion of one surface of a door and having straps or pockets to secure the sheet to a door. Makarevich et al. does not provide for the decoration of the exterior and interior surfaces along a door. The application of Makarevich et al. to cover both surfaces requires an overlapping of straps and/or pockets, thus interfering with the closing and opening of the door and with the decorative features along both sheets.

Kahre, U.S. Pat. No. 5,042,656, discloses a disposable envelope for protecting a door during the painting, construction, and decoration of a building. The cover includes an envelope sealed along three sides and comprised of a flexible, but non-stretchable, plastic or paper. The envelope is large enough to span a door from top to bottom so as to cover the interior, exterior, top, bottom, and lock sides thereof. The open end of the cover is folded over and secured to the hinge side via masking tape or some other temporary fastener. As such, Kahre discloses nothing more than a cover which is at least as large as a door which requires a temporary fastener to properly secure the cover thereto.

Katz, U.S. Pat. No. 4,372,364, discloses a door protector including an adjustable length pad capable of fully covering one surface of a door. The pad includes a pocket which is placed over the top edge of a door and hook-and-loop fasteners at the bottom end so as to allow the pad to be folded over and secured to double the pad thickness adjacent to the lower portion of the door. Katz does not provide for the decoration of the exterior and interior surfaces along a door. Furthermore, the padded construction of Katz interferes with the opening and closing of a door.

Bullock, U.S. patent application Ser. No. 10/210,467, discloses a decorative door cover including a sheet of material sized to cover one face of a door and to extend onto and around the four sides thereof. The sheet has punch-outs that allow a door cover to pass over locks, doorknobs, and hinges. An elastic edging extends across the top and bottom edges of the cover and a pocket at each corner of the sheet fits over the corners of a door. The application of Bullock to cover both exterior and interior surfaces of a door requires an overlapping of elastic edgings and pockets, thus interfering with the closing and opening of a door and with the decorative features along both sheets.

As is readily apparent from the discussions above, the related arts do not include a door covering whereby a flexible fabric material is placed onto the front and back planar surfaces of a door for decorative effect without contacting the side edges of the door and interfering with the mechanical functions, namely, opening, closing, and locking, of the door. Additionally, the related arts do not describe a single, fully-integrated conformal sleeve-shaped device which is easily placed onto and positioned about a door. Furthermore, the related arts do not describe a stretchable fabric sleeve which is secured to a door in a fixed yet removable fashion without the use of fasteners via the contraction of a stretchable fabric along the length of the door.

Therefore, what is required is a low-cost, stretchable fabric covering which facilitates the decoration of both surfaces of a door without compromising the functionality of the door and without the use of fasteners.

### SUMMARY OF THE INVENTION

An object of the present invention is to provide a low-cost, stretchable fabric covering which facilitates the decoration of both surfaces along a door without compromising door functionality and without the use of fasteners.

The conformal door cover includes a sleeve-shaped element having at least one stretchable fabric sheet which conforms to cover the front surface, back surface, top side edge, and bottom side edge of a door without obstructing the function of locks and hinges thereon. Embodiments comprising one fabric sheet include one seam to form the sleeve-shape structure. Embodiments comprising two fabric sheets include two seams with one seam disposed along the cover adjacent to the top side edge of a door and the other seam disposed along the cover adjacent to the bottom side edge of the door. Door covers include first and second decorative sides covering front and back surfaces, respectively, along the door. First and second decorative sides may be identical or different.

In yet other embodiments, the door cover might include one or more openings, one example being a slit, disposed thereon so as to allow entry devices, examples including door handles and knobs, disposed along the door to project through the cover.

The described invention provides advantages over the related arts. The invention is stretchable, thus being adaptable to a variety of door sizes and designs. The stretchable nature of the door cover allows the cover to conform to the door in a self-securing fashion, thus avoiding the use of fasteners and the like. The invention facilitates the decoration of both sides of a door, thus allowing for one or more separate designs along a single door. The invention may be reversible so as to have decorative designs along both inside and outside surfaces of the cover, thus allowing as many as four separate designs.

### BRIEF DESCRIPTION OF THE INVENTION

Additional aspects, features, and advantages of the invention will be understood and will become more readily apparent when the invention is considered in the light of the following description made in conjunction with the accompanying drawings, wherein:

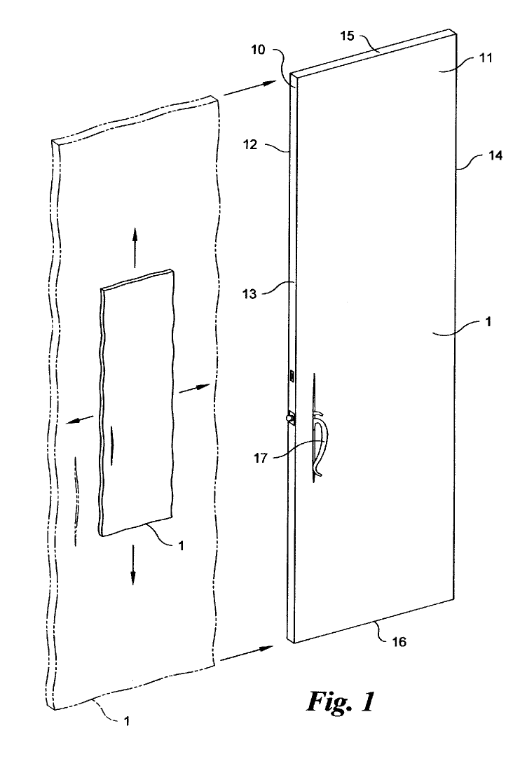

FIG. 1 is a perspective view of the claimed invention showing the conformal door cover disposed about an exemplary entrance door with a slit to accommodate a door handle and lockset.

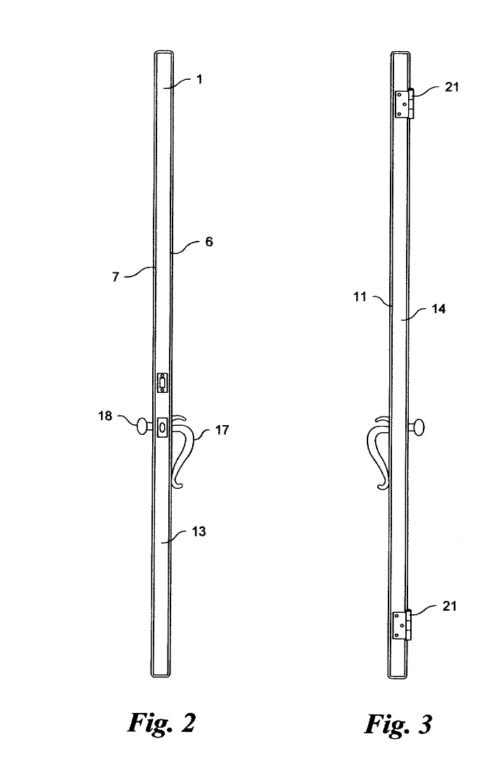

FIG. 2 is an elevation view of the lock side edge showing the conformal door cover disposed about and contacting the front surface, top side edge, back surface, and bottom side edge of a door.

FIG. 3 is an elevation view of the hinge side edge showing the conformal door cover disposed about and contacting the front surface, top side edge, back surface, and bottom side edge of a door.

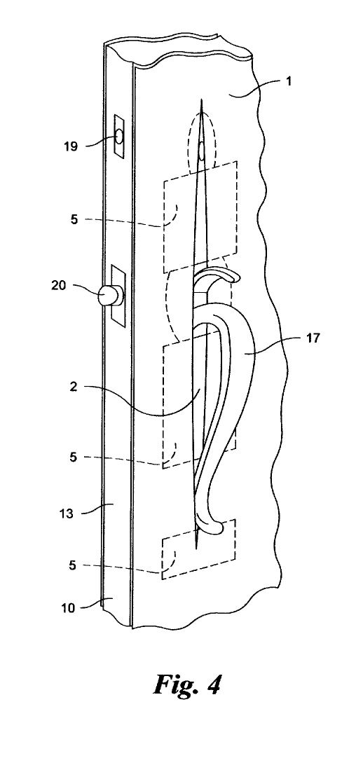

FIG. 4 is a perspective view of a door handle projecting through a slit along the front decorative side of the door cover.

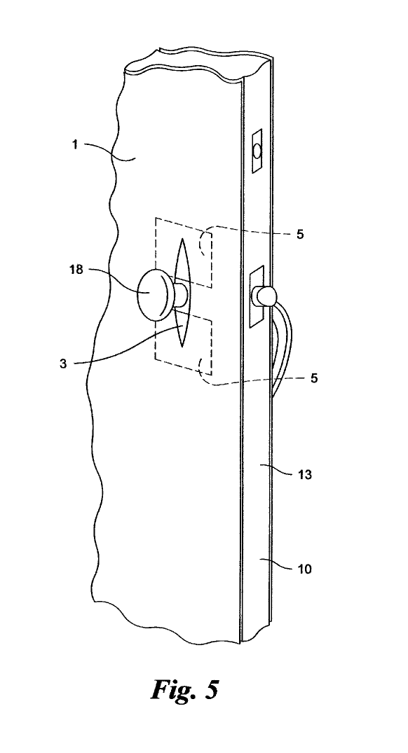

FIG. 5 is a perspective view of a door knob projecting through the slit along the back decorative side of the door cover.

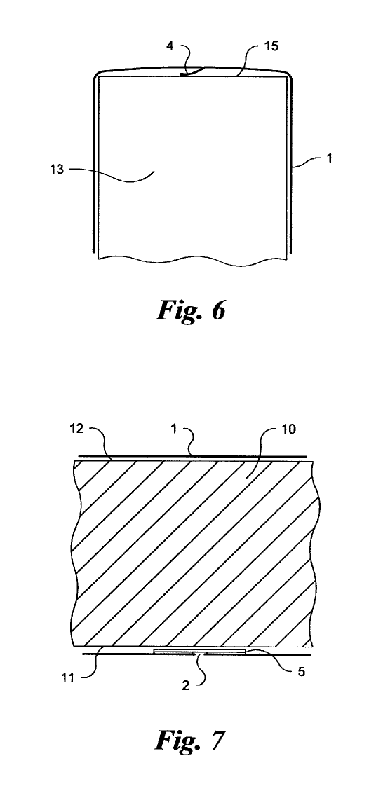

FIG. 6 is an enlarged elevation view of the door edge showing a seam joining two ends of a fabric material to form the sleeve-shaped door cover.

FIG. 7 is an enlarged section view showing the slit along the door cover closed via a fastener element.

### DETAILED DESCRIPTION OF THE INVENTION

Referring now to FIG. 1, the present invention, generally referred to as a door cover 1, is comprised of one or more sheets composed of one or more stretchable materials sewn to form a sleeve-shaped element. The sleeve-shaped element is manufactured from a substantially rectangular-shaped piece of flexible and stretchable fabric material.

Stretchable fabric materials include a variety of stretch knit blends including, without limitation, spandex, which is a generic name for a variety of elastic textile fibers made of polyurethane. Preferred fabrics include blends of spandex with cotton, linen, metallics, nylon, polyester, rayon, silk, terry cloth, velvet, velour, wool, and stretch vinyl. Fabric weight is application dependent. For example, light and medium weight fabrics minimized interaction with the door jam in most residential applications.

Fabrics may include one-way and two-way stretchable materials. One-way stretchable fabrics are preferred to have a length less than the door and a width at least as wide as the door when un-stretched. Two-way stretchable fabrics are preferred to have a length less than the door 10 and a width no wider than the door 10 when un-stretched.

The door cover 1 contacts the front surface 11, back surface 12, top side edge 15, and bottom side edge 16 of the door 10 when stretched and placed over and onto the door 10. While it is preferred for the door cover 1 to completely cover the front surface 11 and back surface 12, the door cover 1 might partially traverse the width of the door 10.

Accordingly, the door cover 1 may include a variety of lengths and widths. For example, in some embodiments the door cover 1 might have an un-stretched length less than the height of the door 10 and an un-stretched width less than the width of the door 10, thus requiring the door cover 1 to be stretched along two axes when placed over a door 10, as represented in FIG. 1. In yet other embodiments, the door cover 1 might have an un-stretched length approximately equal to the height of the door 10 and an un-stretched width less than the width of the door 10, thus requiring the door cover 1 to be stretched along its width axis. In still other embodiments, the door cover 1 might have an un-stretched width which is approximately equal to the width of the door 10 and an un-stretched length less than the height of the door 10, thus requiring the door cover 1 to be stretched along its length axis. In all embodiments, the stretchable fabric should be sufficiently resilient so as to contract along its length after placement onto the door 10, thereby securing the door cover 1 onto the horizontal edges of the door 10 in a fixed but removable fashion.

The edge 8 of the door cover 1 should minimize and preferably avoid contact with the vertically disposed lock side edge 13 and hinge side edge 14. In some embodiments, the edge 8 of the door cover 1 might require a hem to minimize frays and pulls.

Referring now to FIG. 2, the lock side edge 13 is shown with door handle 17 and door knob 18 projecting through the door cover 1. The door cover 1 may include one or more fabric patterns, fabric finishes, decorative designs, and/or ornamental attachments along the planar surfaces of the door cover 1, namely, the front decorative side 6 and/or back decorative side 7. Decorative designs may be either silk screened or printed onto one or both sides of the fabric, as well as along both interior and exterior surfaces of the door cover 1. The door cover 1 may be reversible thus allowing up to two separate designs along the front surface 11 and back surface 12 of the door 10. Ornamental attachments may be either sewn or glued onto the fabric or fastened with a temporary tape or hook-and-loop fasteners. The door cover 1 should minimize and preferably avoid contact with the lock side edge 13 so as to allow the locking hardware, namely, bolts 19, 20, to function without contacting the door cover 1, as represented in FIG. 5.

Referring now to FIG. 3, the hinge side edge 14 is shown with the door cover 1 disposed about the door 10. The door cover 1 minimizes and preferably avoids contact with the hinges 21 disposed along the hinge side edge 14, so as to not interfere with the opening and closing of the door 10.

In some embodiments, it is possible to have the door cover 1 contact and cover entry hardware along one or both side of a door 10. In other embodiments, it might be more advantageous to have the entry hardware project through the door cover 1, so as to be easily accessible.

Referring now to FIGS. 4-5, a door handle 17 is shown projecting through a front opening 2 and a door knob 18 is shown projecting through a back opening 3, respectively, both disposed along a door cover 1. The location and size of front and back openings 2, 3 are dependent on the design of the door 10 and may be either precut into the material during manufacture or cut into the fabric, with scissors or similar cutting instrument, after the door cover 1 is placed onto the door 10. In its simplest form, front and back openings 2, 3 are composed of slits which are cut into the fabric material. In some embodiments, front and back openings 2, 3 might include a hem to minimize frays, tears, and pulls.

One or more fabric sheets or panels are sewn together to form the sleeve-shaped structure of the present invention. For example, one planar sheet of sufficient length to cover the door 10, when folded in two and either stretched or un-stretched, requires a single stitched seam 4, as represented in FIG. 6. In other embodiments, two planar sheets, both of sufficient length and width to cover the door 10, may be aligned and thereafter sewn together via a pair of stitched seams 4 oppositely disposed at either end of the door cover 1. In preferred embodiments, seams 4 are disposed widthwise across the door cover and located adjacent to the top side edge 15 and/or bottom side edge 16 to hide it from view when placed onto a door 10, as represented in FIG. 6.

In some embodiments, it might be advantageous to minimize the width of the front opening 2 and/or back opening 3 about the entry hardware. Referring now to FIG. 7, one exemplary embodiment includes a fastener 5, one example being a hook-and-loop type device, either sewn or glued along both sides of the interior of the door cover 1 about the front opening and/or back opening 2, 3. The front or back opening 2, 3 is closed by securing a single but complimentary fastener 5 to the two interior elements. In other embodiments, the door cover 1 adjacent to the front or back opening 2, 3 might be held together by tape, pins, or fasteners so as to prevent sight lines to the bare door 10.

As is evident from the explanation above, the described invention is capable of covering and conforming to a variety of door types and sizes. Accordingly, the described invention is expected to be used to decorate exterior and interior doors of homes, schools, offices, museums, churches, dorm rooms, shops and the like. Decorative patterns include, without limitation, sports teams, sports players, actors, performers, flags, holiday designs, birthdays, religious symbols, university names and logos, cartoon characters, animals, advertisements, and messages.

The description above indicates that a great degree of flexibility is offered in terms of the present invention. Although the present invention has been described in considerable detail with reference to certain preferred versions thereof, other versions are possible. Therefore, the spirit and scope of the appended claims should not be limited to the description of the preferred versions contained herein.

What is claimed is:

1. A door cover comprising a sleeve-shaped element comprised of at least one stretchable fabric sheet which conforms to a door so as to cover a front surface, a back surface, a top side edge, and a bottom side edge along said door without obstructing the functionality of said door, said stretchable fabric material being resilient along its length so as to contract after placement onto said door.

2. The door cover of claim 1, wherein said sleeve-shaped element has a first decorative side.

3. The door cover of claim 2, wherein said first decorative side is a fabric pattern, a fabric finish, a design, or an ornament.

4. The door cover of claim 1, wherein said sleeve-shaped element has a first decorative side and a second decorative side.

5. The door cover of claim 4, wherein said first decorative side and said second decorative side are identical designs.

6. The door cover of claim 4, wherein said first decorative side and said second decorative side are different designs.

7. The door cover of claim 4, wherein said first decorative side and said second decorative side are a fabric pattern, a fabric finish, a design, or an ornament.

8. The door cover of claim 4, wherein said sleeve-shaped element is reversible having a third decorative side opposite of said first decorative side.

9. The door cover of claim 4, wherein said sleeve-shaped element is reversible having a third decorative side opposite of said first decorative side and a fourth decorative side opposite of said second decorative side.

10. The door cover of claim 1, wherein said sleeve-shaped element includes one said stretchable fabric sheet with one seam.

11. The door cover of claim 1, wherein said sleeve-shaped element includes two said stretchable fabric sheets with two seams whereby one said seam is disposed along said top side edge and another said seam is disposed along said bottom side edge.

12. The door cover of claim 1, wherein said sleeve-shaped element has at least one opening therein so as to allow at least one entry device disposed along said door to project therefrom.

13. The door cover of claim 12, wherein each said opening is a slit.

14. The door cover of claim 13, wherein each said opening having at least one fastener disposed thereabout to close said opening about said entry device.

15. The door cover of claim 1, wherein said sleeve-shaped element is stretchable along one axis.

16. The door cover of claim 15, wherein said sleeve-shaped element is stretchable lengthwise.

17. The door cover of claim 15, wherein said sleeve-shaped element is stretchable widthwise.

18. The door cover of claim 1, wherein said sleeve-shaped element is stretchable along two axes.

19. The door cover of claim 1, wherein said sleeve-shaped element having a length less than said door.

20. The door cover of claim 1, wherein said sleeve-shaped element having a width less than said door.
